(19) United States
(12) Patent Application Publication
(10) Pub. No.: US 2026/0145057 A1
(43) Pub. Date: May 28, 2026

(54) Back Button Structure for Game Controller

(71) Applicant: YUN XIE, Shenzhen City (CN)

(72) Inventor: YUN XIE, Shenzhen City (CN)

(21) Appl. No.: 18/961,303

(22) Filed: Nov. 26, 2024

(51) Int. Cl. A63F 13/24

(52) U.S. Cl. CPC A63F 13/24

(57) ABSTRACT

A back button structure for a game controller includes at least two switches mounted on the back of the controller housing and at least one back button that contacts both switches simultaneously. The back button comprises a main body that is detachably mounted on the back surface of the housing through snap-fits, along with a first and second elastic piece, each formed at opposite ends of the main body and inclined relative to it. A gap is maintained between the inner surfaces of these elastic pieces and the housing's back surface, allowing each elastic piece to contact a switch without relying on the switch's elastic button force for support. This structure achieves a single back button configuration for two switches, enhancing installation efficiency, ease of assembly and disassembly, ensuring the switch's extended durability, and significantly strengthening the controller's overall market competitiveness and appeal.

### FIELD OF THE INVENTION

This invention pertains to the field of game controller technology, specifically to a back button structure for a game controller.

### BACKGROUND OF THE INVENTION

Currently, with the improvement of living standards, game controllers are increasingly used in people's daily lives, and as game controllers continue to evolve, people's requirements for them are also getting higher. At present, game controllers are advancing rapidly and come equipped with various additional functions. For example, Chinese utility model patent ZL202320449360.4 discloses a new type of game controller, which includes: a casing, where two setting buttons, two thumb sticks, a D-pad, two shoulder buttons, four back buttons, and a power button are mounted; a PCB circuit board, installed inside the casing; an ABYX button gear assembly, comprising a transparent silicone pad, ABYX button pressing components, four light guides, ABYX letter switching paddles, four transparent plastic buttons, and an adjustment gear. The transparent silicone pad is placed on the PCB circuit board, the ABYX button pressing components are placed on the transparent silicone pad, and the four light guides are arranged on the transparent silicone pad, each fitting with the ABYX button pressing components. The ABYX letter switching paddles are placed on top of the four light guides.

This game controller utilizes four independent back buttons, each back button corresponding to a switch, with each back button installed in a slidable manner on the casing and in contact with an elastic button on the switch. The back button is supported by the elasticity of the button on the switch.

However, the above back button structure has some shortcomings: since each back button is independent, it requires four separate installations, resulting in low installation efficiency. Each back button relies on the elasticity of the button on the switch for support, which reduces the lifespan of the switch.

In light of this, the inventor has proposed the following technical solution.

### SUMMARY OF THE INVENTION

The purpose of this invention is to overcome the deficiencies in current technology by providing a back button structure for a game controller.

To solve the above technical problem, the invention adopts the following technical solution: the back button structure of the game controller includes at least two switches mounted on the back of the controller casing and at least one back button in simultaneous contact with both switches. This back button includes a main body part that is detachably mounted on the back of the controller casing via a clip, and first and second spring tabs molded on either end of the main body part and inclined relative to it. The inner surfaces of the first and second spring tabs form gaps with the back surface of the controller casing, with the inner surfaces of each tab making contact with one of the two switches.

Further, in the above technical solution, the main body part is equipped with at least two clips, each positioned beside the first and second spring tabs. The back of the controller casing is fitted with slots that correspond to each clip, securing the main body to the back of the casing through the engagement of clips and slots, forming a detachable structure.

Additionally, in this technical solution, each clip is L-shaped and inclined upward relative to the main body part. The outer side of each clip has a notch, and each slot is L-shaped and inclined upward relative to the back of the controller casing, with a slot body that matches the notch. The clip is inserted into the slot at an angle, with the notch positioned in the slot for secure engagement.

Furthermore, the bottom side of the clip is designed with an arched limiting groove, and the bottom edge of the slot has an anti-detachment protrusion to prevent detachment, which fits into the arched limiting groove to restrict the clip in the insertion direction.

In addition, the lower side of the clip and the side of the arched limiting groove feature a convex arc.

Also, in the above technical solution, the anti-detachment protrusion has an arched shape.

Moreover, each clip includes a horizontal bar section connected to a vertical bar section that is perpendicular to the horizontal bar section. The arched limiting groove is situated on the lower surface of the horizontal bar section, and the notch is positioned on the left or right side of the vertical bar section.

In the above technical solution, the two clips are symmetrically distributed on the inner surface of the main body part.

Further, in the above technical solution, each of the first and second spring tabs is formed with a contact rod that is compatible with the switches, with the end of each contact rod embedded in a groove of a switch.

In addition, the number of switches is four, arranged in pairs symmetrically on the back of the controller casing. The number of back buttons is two, each back button paired with two switches and symmetrically arranged.

By adopting the above technical solution, this invention has the following beneficial effects compared to existing technology: the back button structure in this invention features first and second spring tabs, effectively functioning as two back buttons on a conventional game controller. The inner surfaces of the first and second spring tabs correspond to and contact the two switches, thereby enabling one back button to work with two switches. This structure is efficient to install and easy to disassemble, while the gaps formed between the inner surfaces of the first and second spring tabs and the back of the controller casing eliminate the need for support from the switch's elastic button. This arrangement extends the lifespan of the switches, giving this invention strong market competitiveness.

### BRIEF DESCRIPTION OF THE DRAWINGS

FIG. 1 is a perspective view of the invention;

FIG. 2 is an exploded perspective view of the invention;

FIG. 3 is a perspective view of the controller casing in the invention;

FIG. 4 is another perspective view of the controller casing in the invention;

FIG. 5 is a sectional view of the controller casing in the invention;

FIG. 6 is a sectional view of the invention;

FIG. 7 is a sectional view of the invention from another angle;

FIG. 8 is a perspective view of the back button in the invention.

### DETAILED DESCRIPTION OF THE EMBODIMENTS

The following further describes this invention in combination with specific embodiments and accompanying drawings.

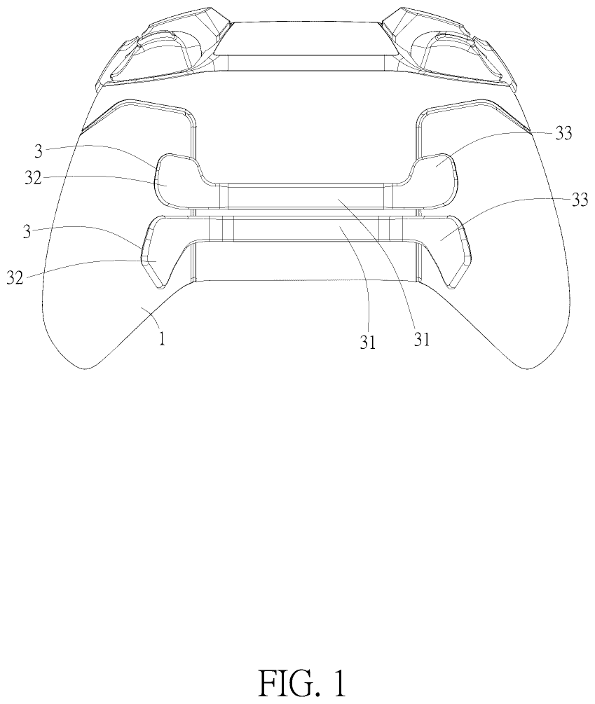

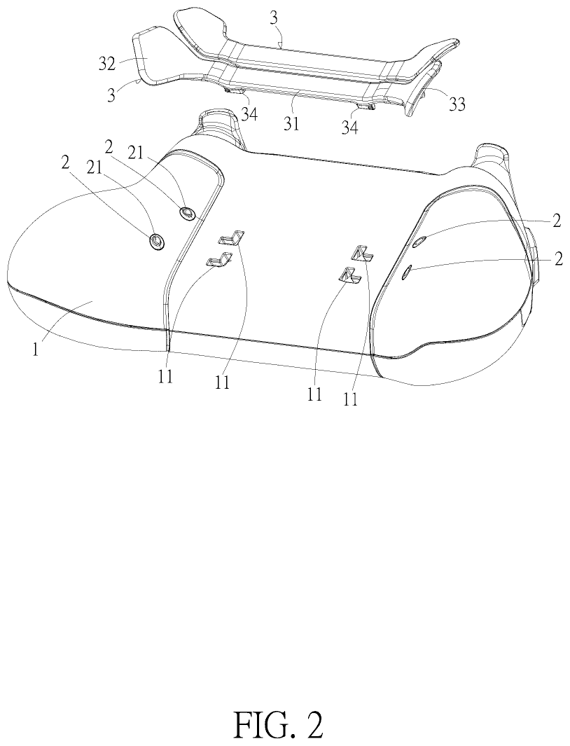

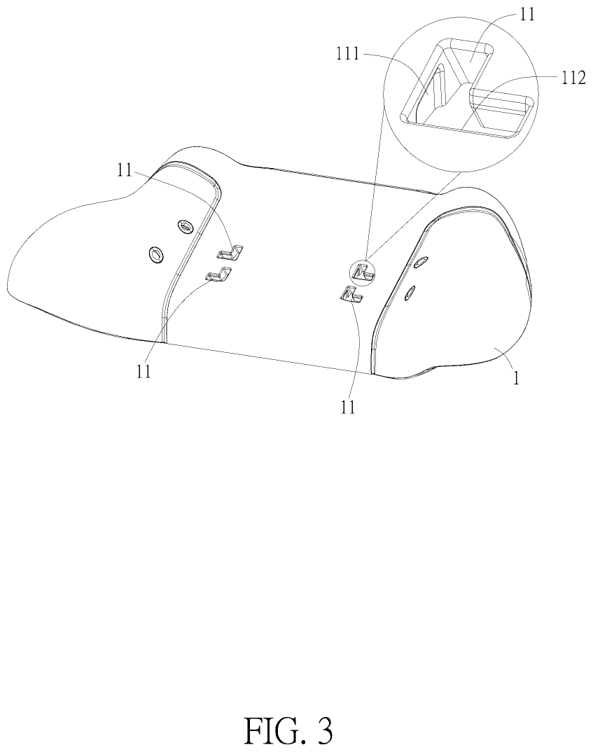

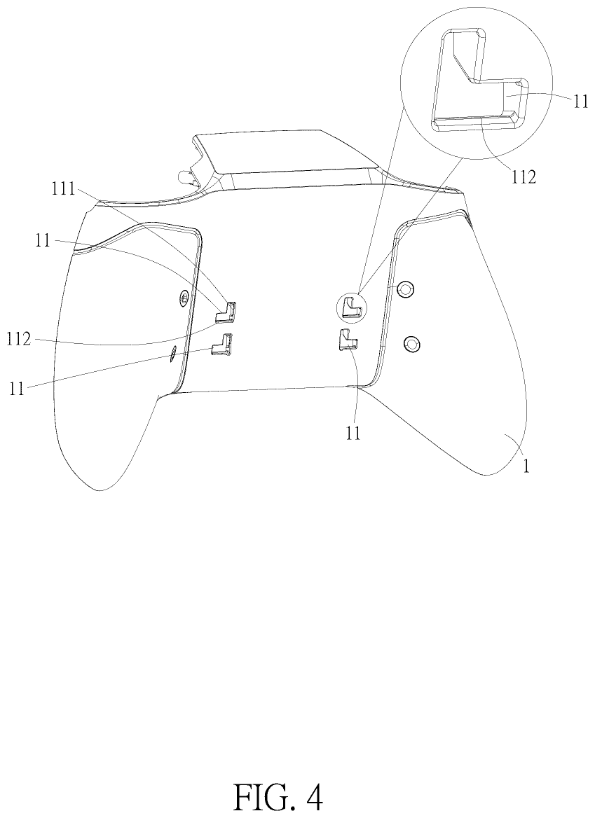

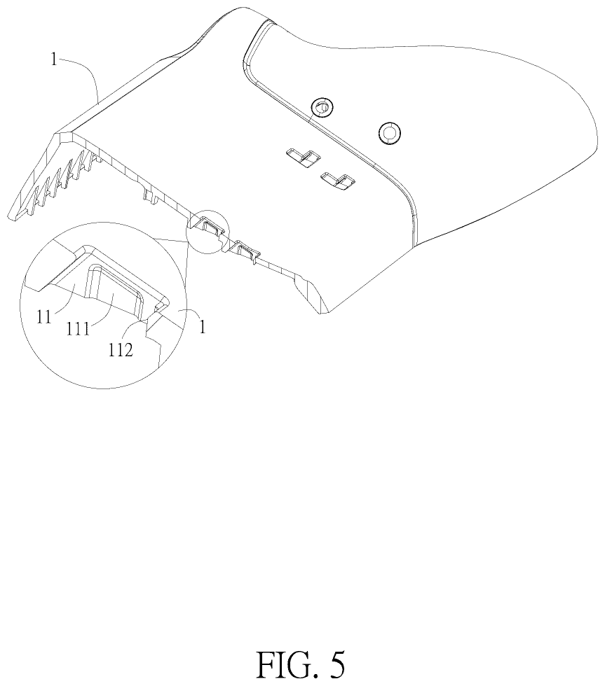

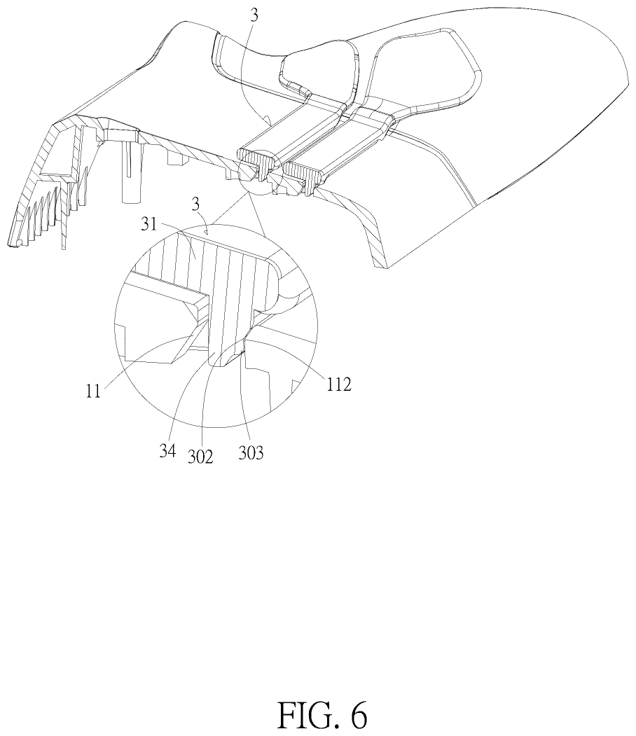

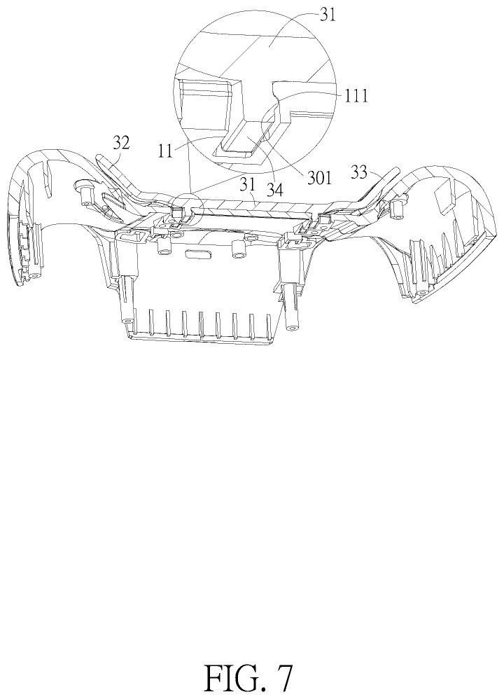

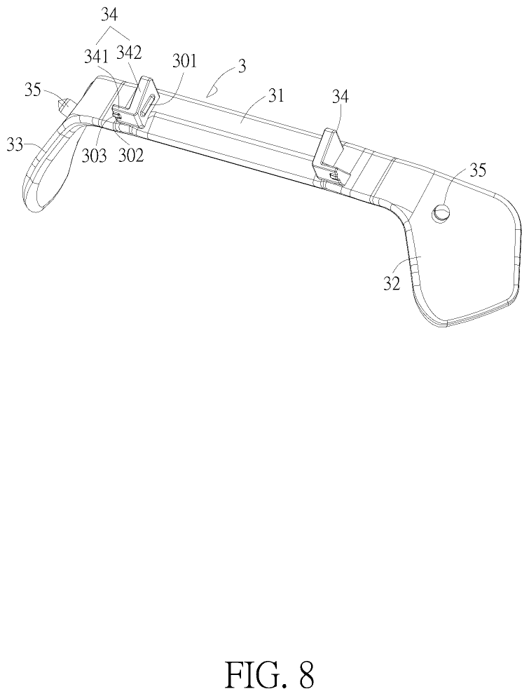

Referring to FIGS. 1-8, the back button structure of a game controller includes at least two switches 2 mounted on the back of the controller casing 1 and at least one back button 3 in simultaneous contact with both switches 2. The back button 3 includes a main body part 31 that is detachably mounted on the back of the controller casing 1 through clips, and first and second spring tabs 32 and 33 molded on either end of the main body part 31 and inclined relative to it. Each inner surface of the first and second spring tabs 32 and 33 forms a gap with the back of the controller casing 1, and the inner surfaces of the first and second spring tabs 32 and 33 make contact with the two switches 2 correspondingly. This design allows the back button 3, with its first and second spring tabs 32 and 33, to function similarly to two separate back buttons on a conventional game controller, enabling one back button to contact two switches 2. This design enhances installation efficiency and allows for convenient disassembly. Additionally, the gaps formed between the inner surfaces of the first and second spring tabs 32 and 33 and the back of the controller casing 1 mean that the spring tabs do not rely on the elasticity of the button on the switch for support, thereby extending the lifespan of the switches 2, and making the invention highly competitive in the market.

In this embodiment, the main body part 31 is equipped with at least two clips 34, positioned on either side of the first and second spring tabs 32 and 33. The back of the controller casing 1 is equipped with slots 11 that correspond to each clip 34, securing the main body part 31 to the back of the casing through the engagement of clips 34 and slots 11, forming a detachable structure. The engagement of two clips 34 with two slots creates an extremely stable assembly structure, holding the main body part 31 securely against the back of the controller casing 1. This stability ensures that the entire back button 3 remains balanced, with the inner surfaces of the first and second spring tabs 32 and 33 in precise contact with the two switches 2, thereby preventing misalignment that could interfere with this contact.

Each clip 34 is L-shaped and inclined upward relative to the main body part 31, with a notch 301 on its outer side. Each slot 11 is also L-shaped and inclined upward relative to the back of the controller casing 1, with an inner wall that forms a slot body 111 adapted to match the notch 301. The clip 34 is inserted into the slot 11 at an angle, with the notch 301 positioned to engage the slot body 111, providing stable positioning between the clip 34 and slot 11. Applying force to the back button 3 detaches the notch 301 from the slot body 111, allowing easy removal of the back button 3 from the controller casing 1.

To prevent the clip 34 and slot 11 from separating too easily—and to ensure that the back button 3 is not overly easy to detach from the controller casing 1—additional structures are provided. The bottom side of the clip 34 is designed with an arched limiting groove 302, and the bottom edge of the slot 11 has an anti-detachment protrusion 112 to prevent detachment, which fits into the arched limiting groove 302 to restrict the insertion direction of the clip 34. In other words, when the clip 34 is inclinedly inserted into the slot 11, the notch 301 is positioned to engage the slot body 111, while the anti-detachment protrusion 112 fits into the arched limiting groove 302, preventing easy detachment of the clip 34 and slot 11 and ensuring the stability of the back button 3 on the back of the controller casing 1.

Additionally, for enhanced stability in the assembly of the back button 3 with the controller casing 1, the following design is included: the bottom side of the clip 34 and the side of the arched limiting groove 302 feature an arc-shaped convex portion 303. When force is applied to detach the back button 3, the anti-detachment protrusion 112 can quickly slide over the arc-shaped convex portion 303 once it exits the arched limiting groove 302, facilitating removal. Similarly, during installation, when the clip 34 is inclinedly inserted into the slot 11, the anti-detachment protrusion 112 first contacts the arc-shaped convex portion 303 and smoothly passes over it to enter the arched limiting groove 302, making assembly easier.

The anti-detachment protrusion 112 is arched in shape, allowing it to settle into and easily detach from the arched limiting groove 302, which facilitates the attachment and removal of the back button.

Each clip 34 comprises a horizontal bar section 341 connected to a vertical bar section 342 that is perpendicular to it. The arched limiting groove 302 is situated on the lower surface of the horizontal bar section 341, while the notch 301 is positioned on either the left or right side of the vertical bar section 342.

The two clips 34 are symmetrically distributed on the inner surface of the main body part 31, ensuring the back button is stably assembled onto the controller casing 1.

Both the first and second spring tabs 32 and 33 have inner surfaces that are molded with contact rods 35 adapted to match the switches 2. The ends of these contact rods 35 are embedded in the grooves 21 of the switches 2, ensuring a stable assembly of the contact rods 35 with the switches 2.

The controller has four switches 2, arranged in pairs symmetrically on the back of the controller casing 1. There are two back buttons 3, each back button installed for a pair of switches 2, with the two back buttons symmetrically arranged.

In summary, the back button 3 in this invention features first and second spring tabs 32 and 33, serving a similar function to two separate back buttons on a conventional game controller. The inner surfaces of the first and second spring tabs 32 and 33 make precise contact with two corresponding switches 2, allowing one back button to fit two switches 2. This design improves installation efficiency, allows for easy assembly and disassembly, and avoids relying on the elasticity of buttons on the switches for support. Consequently, this design helps extend the lifespan of the switches 2, giving the invention strong market competitiveness.

Of course, the above description is merely a specific embodiment of the invention and is not intended to limit the scope of the invention. Any equivalent changes or modifications made based on the structure, features, and principles described in the patent application scope of this invention should be included within the scope of this patent application.

I claim

1. A back button structure for a game controller, comprising:
at least two switches (2) mounted on a back of a controller casing (1) and at least one back button (3) that simultaneously contacts the two switches (2);
wherein the back button (3) comprises a main body part (31) that is detachably mounted on the back of the controller casing (1) via a clip, and a first elastic tab (32) and a second elastic tab (33) formed respectively at both ends of the main body part (31) and inclined relative to the main body part (31);
both inner surfaces of the first elastic tab (32) and the second elastic tab (33) form a gap with the back of the controller casing (1);
the inner surfaces of the first elastic tab (32) and the second elastic tab (33) contact the two switches (2) correspondingly.

2. The back button structure for the game controller according to claim 1, wherein the main body part (31) is provided with at least two clips (34) positioned respectively next to the first elastic tab (32) and the second elastic tab (33); the back of the controller casing (1) has slots (11) corresponding to the clips (34) one-to-one, and the main body part (31) is attached to the back of the controller casing (1) and fixed by engaging the clips (34) with the slots (11) to form a detachable structure.

3. The back button structure for the game controller according to claim 2, wherein the clip (34) is L-shaped and is inclined upward relative to the main body part (31); an outer side of the clip (34) is provided with a notch (301) ; the slot (11) is L-shaped and inclined upward relative to the back of the controller casing (1), with a slot body (111) on the inner wall that fits the notch (301) of the clip (34) to lock the position.

4. The back button structure for the game controller according to claim 3, wherein an arched limiting groove (302) is provided on the lower side of the clip (34), and the lower edge of the slot (11) has an anti-detachment protrusion (112) that fits into the arched limiting groove (302) to restrict the insertion direction of the clip (34).

5. The back button structure for the game controller according to claim 4, wherein an arc-shaped convex portion (303) is formed on the lower side of the clip (34) adjacent to the arched limiting groove (302).

6. The back button structure for the game controller according to claim 4, wherein the anti-detachment protrusion (112) is arc-shaped.

7. The back button structure for the game controller according to claim 3, wherein the clip (34) comprises a horizontal bar section (341) and a vertical bar section (342) connected to an end of the horizontal bar section (341) and perpendicular to the horizontal bar section; the arched limiting groove (302) is provided on a lower surface of the horizontal bar section (341), and the notch (301) is provided on the left/right side surface of the vertical bar section (342).

8. The back button structure for the game controller according to claim 1, wherein the two clips (34) are symmetrically distributed on the inner side of the main body part (31).

9. The back button structure for the game controller according to claim 1, wherein the inner surfaces of the first elastic tab (32) and the second elastic tab (33) are each formed with a contact rod (35) that is adapted to the switch (2), and the end of the contact rod (35) is embedded in the groove (21) of the switch (2).

10. The back button structure for the game controller according to claim 1, wherein the number of the switches (2) is four, which are symmetrically distributed in pairs on the back of the controller casing (1); the number of the back buttons (3) is two, each back button (3) being mounted to correspond to one pair of switches (2), and the two back buttons (3) are symmetrically distributed.
